(19) United States
(12) Patent Application Publication
(10) Pub. No.: US 2014/0208671 A1
(43) Pub. Date: Jul. 31, 2014

(54) METHODS AND DEVICES FOR UTILIZING A THERMALLY-EFFICIENT BUILDING BLOCK

(71) Applicant: RON ZOHAR, Rehovot (IL)

(72) Inventor: RON ZOHAR, Rehovot (IL)

(21) Appl. No.: 13/752,411

(22) Filed: Jan. 29, 2013

(51) Int. Cl. E04C 1/39; E06B 7/02; E04C 1/42

(52) U.S. Cl. CPC E04C 1/392; E04C 1/42; E04C 1/397; E06B 7/02
USPC 52/209; 52/503; 52/306; 52/741.4

(57) ABSTRACT

The invention discloses devices and methods utilizing a thermally efficient building block. The block generally has three walls separated by two open spaces. One open space, the closest to the outside of the building, generally serves to remove unwanted heat entering through the outer wall of the block; the second open space is adapted to accept infrastructure elements such as wires, cables, and pipes. The block prevents unwanted heat from entering usable spaces while also protecting heat generated within a structure.

### FIELD AND BACKGROUND OF THE INVENTION

The present invention, in some embodiments thereof, relates to methods and devices for allowing improved control of energy entering or departing a building. The instant invention, in some embodiments, describes a thermally efficient block that removes solar energy from glass-enclosed buildings prior to said energy heating usable spaces of such buildings.

Major cities throughout the world are defined by their ever growing skylines. Massive towers, clad in colored glass, have become routine fixtures in cities throughout the world. Their beauty defines their locality and their functionality allows for thousands of people to work in a single building. One challenge with any building is heating and cooling. Summer and winter present their temperature challenges, and all buildings are equipped with systems for keeping the interior spaces at a temperature where people can easily work and live.

Sixty percent of electricity used in a modern skyscraper is related to heating/cooling costs. The massive glass panels associated with the most sophisticated of skyscrapers from Beijing to Dubai to Los Angeles are physically beautiful but are ideal for both allowing unwanted solar energy to enter a building as well as let hot air escape during the winter. The State of Illinois building in Chicago (The James R. Thompson Center) designed by Helmut Jahn was unusable after its opening: failed air conditioning systems left glass-exterior offices at well over 100 degrees Fahrenheit. Workers had to be sent home until the problem could be fixed.

Glass-enclosed buildings are not the only ones that allow in excess solar energy and allow for loss of heat during the winter. China has seen over 100 million air conditioning units sold over the past several years, while Americans pay a fair amount of money (somewhat reduced with the new natural gas finds in the US) to keep large, oftentimes energy leaky houses, warm in the winter. A thermally efficient building block that allows for both structural beauty as well as heightened energy efficiency would considerably reduce the energy expended for heating/cooling of structures, both large and small.

U.S. Pat. No. 4,529,652 to Comma et al. teaches a method of manufacturing a thermally insulated building block (54a) comprises foaming a quantity of foamable plastics material in an enclosed space (56) between a building block (54) and a closure means (52), the quantity of material being sufficient to fill the enclosed space (56). The foamable material may be injected into a cavity in the block onto an outer surface of the block (54) or onto the closure means (52) prior to locating the block (54) and closure means (52) relative to each other to form the enclosed space (56) therebetween. The block (54) is transported between upper and lower parallel endless belts (55, 50) during foaming and either belt (55, 50) may provide the closure means (52). If the lower belt (50) provides the closure means (52) the upper belt (55) maintains the block (54) in contact with the closure means (52) during foaming.

European Patent EP0036156B1 to Pricker & Scholz describes an all-metal construction thermal insulating building block, the dimensions of which can be varied, comprising metallic insulating foils which are spaced from one another and mounted so as to be thermally mobile, and which form insulating cells lying between them, spacing elements which space the insulating foils from one another, and casing plates which carry and at least partially surround the insulating foils and spacing elements, characterized in that the building block (2b, 2c, 2d) consists of at least two building block parts which with their casing plates (8) and with their insulating foils (6), are in each case mutually packed in one another juxtaposed in a convection-retarding sliding fit; and that in the direction of thrust (LS, TS) of the sliding-fit, overlapping sections (10) exist in each case between the juxtaposed insulating foils (6) and casing plates (8), which sections are greater than the predetermined maximum enlargement of the building block (2b, 2c, 2d) produced by pulling apart parts of the building block in the direction of thrust.

European Patent EP0963491A1 to Haener teaches an insulated building block system for use in building walls and other structures. Each full block (12) has sidewalls (16) and endwalls (18) with a generally open interior and flat upper and lower surfaces. Two vertical ridges (20) are provided along the interior clone sidewall, with a protrusion (22) extending above the upper surface. The ridges (20) are located such that an upper block arranged in staggered relationship to a block in a lower course will interlock with the lower block. Recesses are provided in the interior endwall surfaces to retain a thermal insulation panel (30) against the interior sidewall surface opposite the ridges. Half blocks (14) are also provided to fill spaces in wall end surfaces between staggered full blocks. The half blocks have open interiors for placement of insulation panels (42) and include ridges for interlocking with protrusions on adjacent full blocks (12).

European Patent EP 0438110 A1 to Kline describes an architectural building block (10) is formed of light transmitting, molded plastic material to resemble a common glass block or brick and comprises a plurality of hollow half members (12,14) joined together along a seam (16) to form a hollow block enclosure with the seam spaced intermediately between a pair of opposite planar outer side faces (18,20) of the block Each half member (12,14) has an inner surface (19,21) and an outer surface (18,20) comprising one of the outer side faces of the block integrally joined around its periphery to an inwardly directed peripheral edge flange (22,24) having a free edge providing one Joining edge of the seam. At least one of the outer opposite side faces of the block is provided with a thin, hard, transparent, abrasion, chemical and ultraviolet light resistant protective coating of plastic resin permanently bonded to an outer side face of the block to provide protection from the environment and weather.

Another European Patent to Kline (EP 0452879 B1) teaches an architectural building block (10) formed of light transmitting, molded plastic material to resemble a common glass block and comprising: a plurality of hollow half members (12, 14) joined together along a seam (16) to form a hollow block enclosure with said seam spaced intermediately between a pair of opposite outer side faces (18, 20) of said block, each half member (12, 14) having an inner surface and an outer surface comprising one outer side face of said block (10) of polygonal shape integrally joined around its periphery to an inwardly directed continuous peripheral edge wall (20, 24) having a plurality of angularly intersecting wall segments (25) normal to said outer side face (18, 20) and a continuous free edge providing one joining edge of said seam (16); flange means (30) formed along at least one of said wall segments (25) aligned to extend outwardly of said side face (18, 20) for at least partially filling a precise amount of space established between a pair of adjacent blocks (10) when said blocks are positioned with respective wall segments (25) thereof in spaced apart confronting relationship for forming a wall structure including said pair of blocks (10); and connector means (40) including a pair of interlockable tongue (42, 43, 48) and slot (44) forming elements, aligned on said flange means (30) for detachably securing said adjacent blocks (10) together, said slot (44) forming elements being integrally formed on said flange means (30); characterized in that said flange means (30) comprise a plurality of flange segments (52) spaced apart in a row along said wall segment (25) providing spaces (54) between adjacent segments (52) in said row suitable for receiving liquid adhesive joining material (38), and said tongue (42, 43, 48) forming elements of said connector means (40) are likewise integrally formed with said flange means (30).

The prior art generally describes building blocks that make use of insulation or other physical properties to reduce energy penetration into a built structure.

### SUMMARY OF THE INVENTION

It is therefore a purpose of the present invention, in some embodiments, to provide a thermally efficient block including three parallel walls defining two open spaces.

The invention includes a thermally efficient building block including the following: three parallel walls of similar dimensions, the walls being composed of predetermined materials and attached at points at the base and top of the walls, wherein the walls may be made of the same or different materials and the points of attachment create a first open space between a first of the walls and a second of the walls, as well as a second open space between the second of the walls and a third of the walls, wherein the first open space is adapted to allow for the flow of hot air upwards and away from the second of the walls.

In one aspect of the block, the walls are made of optically-clear materials.

In another aspect of the block, the block is used in the construction of a multi-story building.

In another aspect of the block, the second open space is adapted to receive infrastructure elements.

In another aspect of the block, the infrastructure elements include pipes, wires, cables, and insulation.

In another aspect of the block, the spacing between the first of the walls and the second of the walls is twenty centimeters.

In another aspect of the block, the spacing between the second of the walls and the third of the walls is twenty centimeters.

In another aspect of the block, the stacking of a plurality of the blocks leads to a first continuous open space comprised of multiple first open spaces and a second continuous open space comprised of multiple second open spaces.

In another aspect of the block, the first wall is realized as a window and the third wall is realized as dryboard or concrete.

The invention includes a method for preventing thermal energy from entering the usable space of a building via a window, including: providing a thermally-efficient block, the block having a window defining an outer wall, a first open space between the window and a second wall, and a second open space between the second wall and a third wall, wherein the third wall serves as an internal wall within the building; allowing sunlight to penetrate the window; allowing air heated by the sunlight in the first open space to travel upwards away from the second wall; and, removing the air from the upper region of the building.

In one aspect of the method, the window is tinted.

In another aspect of the method, the window includes at least one chemical coating against glare or heat transfer.

In another aspect of the method, the upper region is realized as the roof of the building.

In another aspect of the method, the second wall and the third wall are optically-transparent.

In another aspect of the method, infrastructure elements are run through the second open space.

The invention further includes a thermally efficient building block for reducing heating and cooling expenses for a structure, including the following: a building block defined by three connected and parallel surfaces separated by two open cavities, the open cavities being substantially open on the top and bottom, wherein the cavities allow for the passage of infrastructure elements as well as control of movement of hot and cold air between the surfaces; and, a connector block, wherein the connector block has a generally T-shaped structure and is adapted to attach to and hold in place two of the building blocks, and wherein the connector block is substantially open so as to allow for the control of movement of hot and cold air between the surfaces.

In one aspect of the block, all external walls of the structure are built with the block and the connector block

In another aspect of the block, hot air is allowed to travel up through at least one of the two open cavities.

In another aspect of the block, the surfaces are made of different materials.

In another aspect of the block, the block is realized as a plurality of blocks ad the connector block is realized as a plurality of connector blocks.

The invention additionally includes a thermally efficient window for use in construction of a building, including the following: three parallel panes of optically-clear material of similar dimensions, the panes being composed of predetermined materials and attached at points at the base and top of the panes, wherein the panes may be made of different materials and the points of attachment create a first open space between a first of the panes and a second of the panes, as well as a second open space between the second of the panes and a third of the panes, wherein the first open space is adapted to allow for the flow of hot air upwards and away from the second of the panes and out of the building.

Unless otherwise defined, all technical and/or scientific terms used herein have the same meaning as commonly understood by one of ordinary skill in the art to which the invention pertains. A “block” or “thermal block” for the present invention may generally describe a block with improved control over energy entering and leaving a building built with such a block. A thermal block may be used in the construction of houses, factories, buildings and other structures as well as mobile elements such as cars, ships, and planes. Materials amenable for use in the present block are not limited but may include both natural as well as synthetic substances. Glass, glasslike products, ceramics, concrete, composite materials, wood, steel, aluminum, and stone are non-limiting examples of materials possibly used for the walls associated with blocks according to embodiments of the instant invention. The term “thermal block” may generally refer to a block that has improved thermal properties for keeping unwanted heat and cold out of a building or structure and for keeping desired heat or cold in the same building or structure. “Infrastructure elements” may generally refer to pipes, wires, insulation, cables or the like that involved in electrical, phone, internet, water, steam, heat or other systems associated with a house, building, or structure. Such elements, in some embodiments of the instant invention, may be placed in open spaces in thermal blocks and out of sight of inhabitants, dwellers, or users of a building constructed with such thermal blocks.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. It is noted that similar elements in various drawings will have the same number, advanced by the appropriate multiple of 100.

In the drawings:

FIGS. 1A-1C show schematic views of prior art window arrangements;

FIGS. 2A-2D show schematic views of a thermal block according to an embodiment of the instant invention wherein all of the walls of the block are made of the same optically clear material;

FIGS. 3A-3F show schematic views of an embodiment of a thermal block wherein the walls associated with a block are made of different materials;

FIG. 4 shows a diagram of a method associated with the instant invention,

FIGS. 5A-5B show schematic views of thermal blocks adapted to keep cool air and warm air in room and not let such air escape a building; and,

FIGS. 6A-6F show schematic views of connector blocks for the joining of thermal blocks to form floor/ceiling interfaces.

### DESCRIPTION OF SPECIFIC EMBODIMENTS OF THE INVENTION

The present invention, in some embodiments thereof, relates to a thermal block that may generally have three parallel walls with two separating regions for thermal control as well as placement of infrastructure elements.

For purposes of better understanding, some embodiments of the present invention are illustrated in the figures of the drawings.

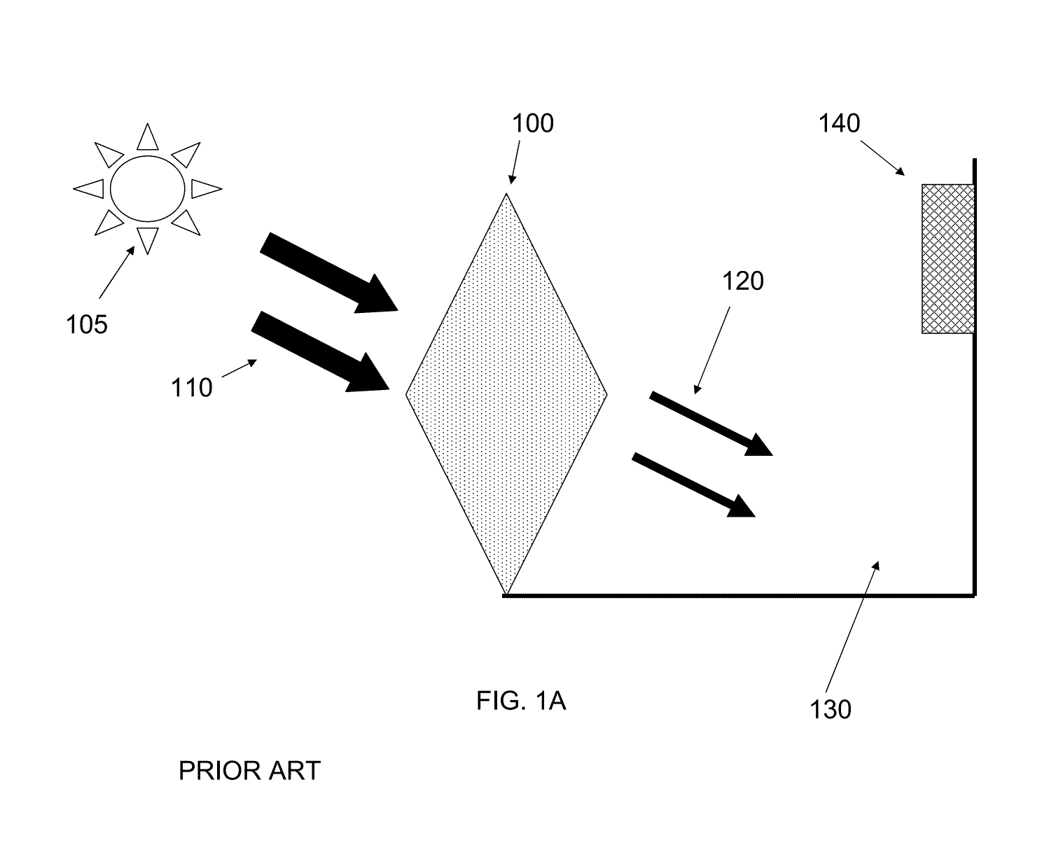

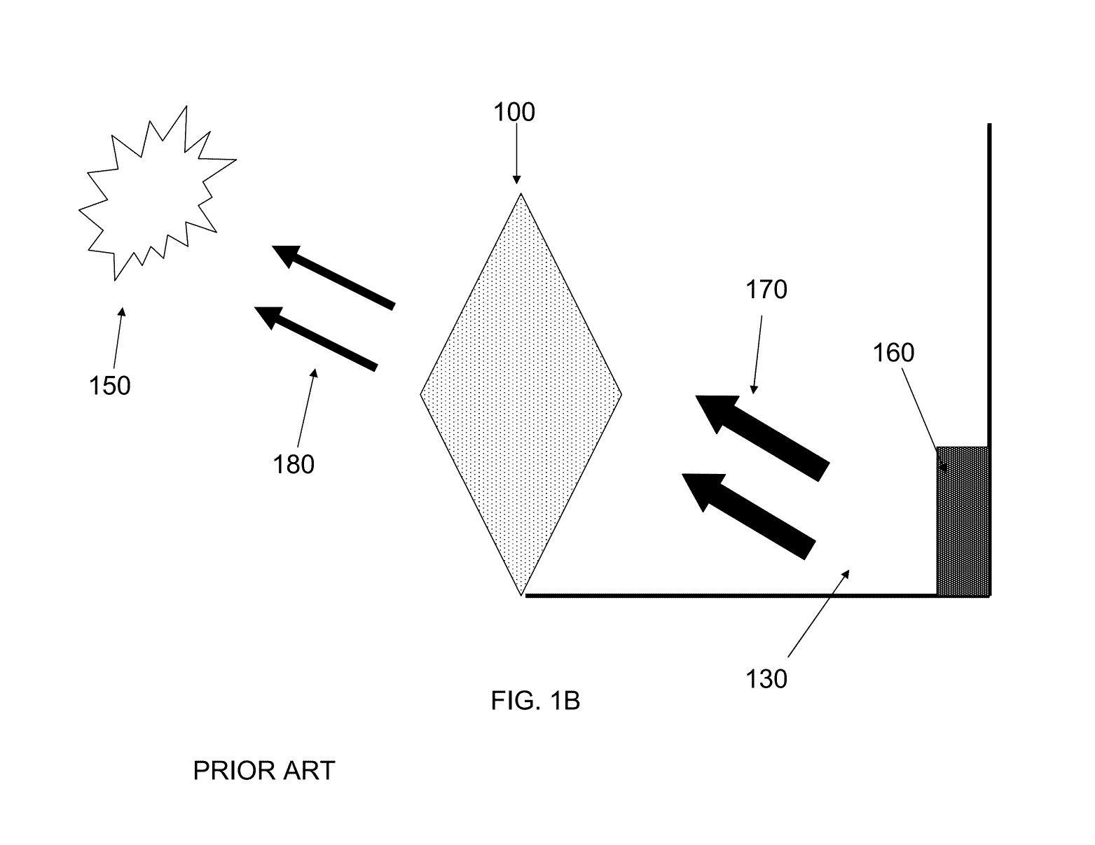

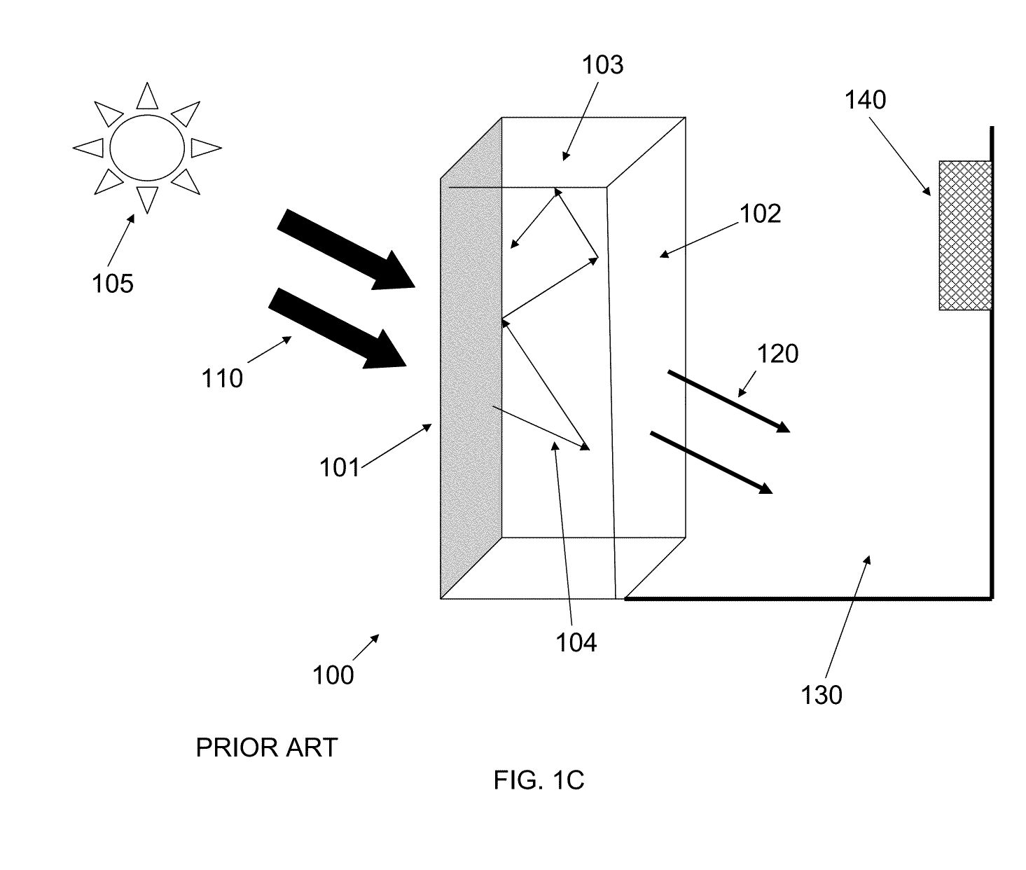

Attention is turned to FIG. 1A which shows a prior art view of a window used in typical construction methods. The sun 105 provides thermal energy 110 which may penetrate in part 120 a window 100 and allow for heating of a room 130. In this figure, a single-pane window 100 is shown and a great deal of energy 120 may pass into the room 130 and cause undesired heating. An air-conditioner 140 or similar element may be employed to cool the room 130 and remove the undesired heat energy 120 delivered to the room 130. Not shown are curtains, blinds, or window 100 coatings that might reduce the amount of sun 105 energy 110 entering 120 the room 130.

Attention is turned to FIG. 1B which shows a prior art window 100 during cloudy 150 or winter days. Energy 170 produced by a radiator 160 or other means (not shown) leaves 180 the room 130 through a window 100. The single-pane window 100 provides little protection from energy loss 180 and additional radiator 160 energy 170 is required to heat the room 130. The energy required of the radiator 160 or air-conditioner (FIG. 1A, 140) is wasted due to energy inefficiency of the window 100 both in allowing too much energy to enter (FIG. 1A) and to leave (FIG. 1B).

Attention is turned to FIG. 1C, which shows a schematic view of a prior art double-pane window 100 used for construction of private and public structures. The window 100 includes an outer pane 101 and an inner pane 102 as well as a closed inner space 103. The inner space 103 is not shown to true dimensions for the purpose of illustration only. Sun 105 energy 110 passes through the outer pane 101 and a portion 104 of the energy remains in the closed inner space 103, while a portion 120 passes into a room 130. The inner space 103 generally is filled with air, though it may be composed of a vacuum or a predetermined gas. It is understood that multi-pane systems (three or more parallel panes) may be used but would be similar to the arrangements shown in FIG. 1C, wherein a closed space 103 is created between two panes 101 & 102 and is enclosed on all sides. The advantages of this system may include less heat energy 120 entering a room 130 due to the presence of two panes 101 & 102. Yet that very advantage becomes a disadvantage, as the air in the inner space 103 is heated as suggested by trapped heat 104. This air acts as a mini-radiator to continue to provide heat energy 120 into the room 130 even after the sun 105 has gone down or is covered with a cloud (not shown). An air-conditioner 140 is still required for cooling the room 130 due to the excess thermal energy 120 that penetrates the double panes and/or is radiated from the trapped heat energy 104 in the closed inner space 103.

### First Embodiment

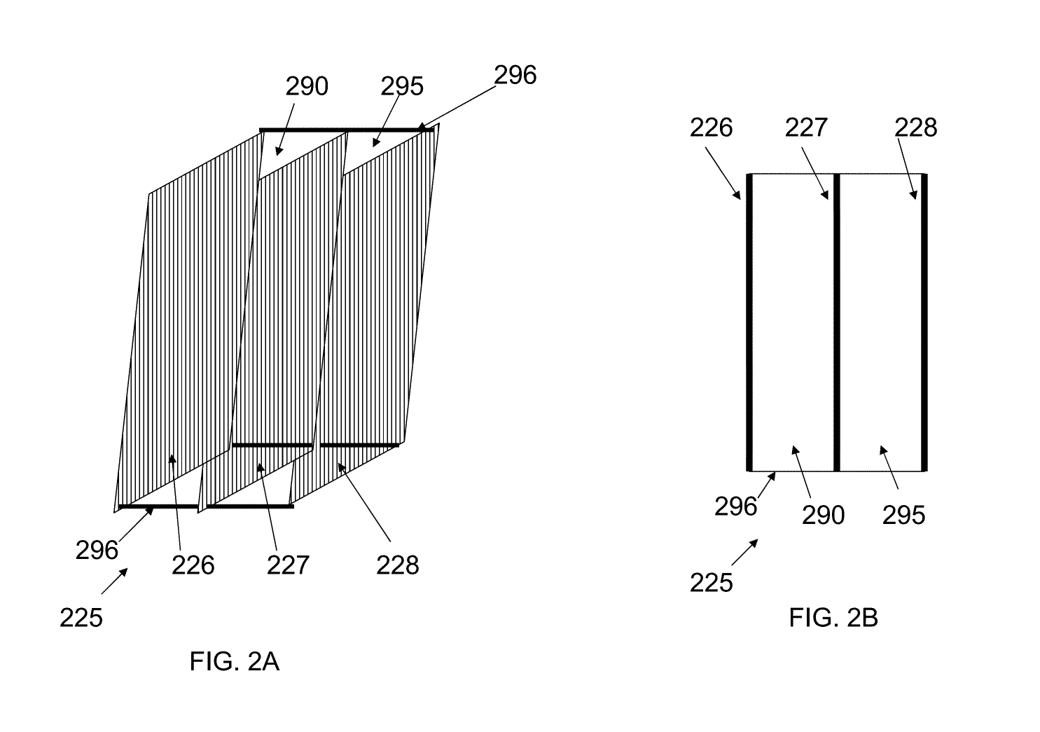

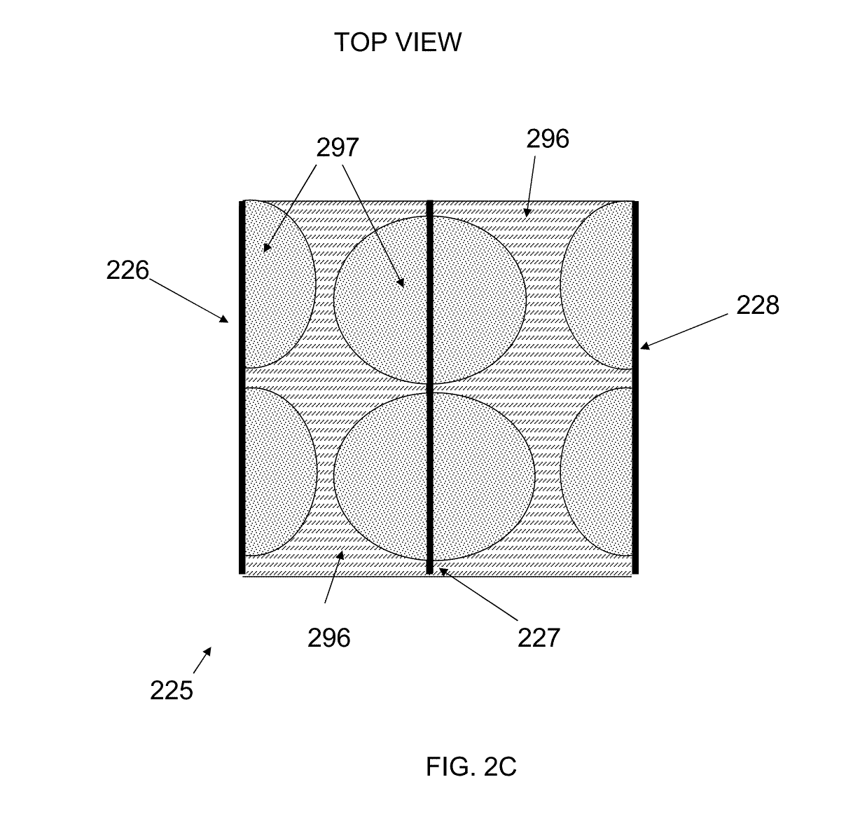

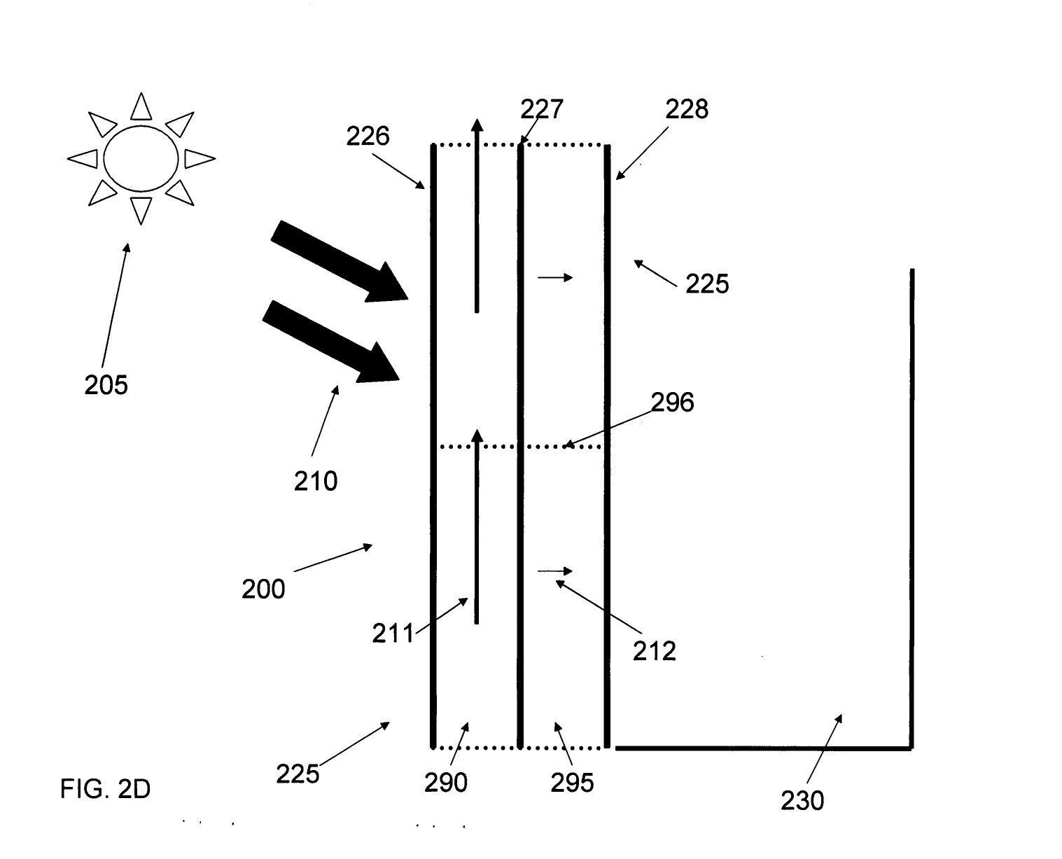

Attention is turned to FIG. 2A which shows a schematic embodiment of a thermal block 225 according to an embodiment of the instant invention. The view is a side view on an angle relative to the block 225. The block 225 includes a first wall 226, a second wall 227, and a third wall 228, with a first open space 290 between the first wall 226 and the second wall 227 and a second open space 295 between the second wall 227 and the third wall 228. The walls are connected with connecting elements 296 between walls 226 and 227, as well as between walls 227 and 228 to form a solid, single thermal block 225. The walls 226, 227 & 228 are generally parallel to one another and have generally identical length, width, and thickness, while the open spaces 290 & 295 generally have identical volumes, though such arrangements are not necessary for practicing the instant invention. FIG. 2B shows a perpendicular side view of the same thermal block 225 showing the walls 226, 227 & 228 as well as the open spaces 290 & 295 as well as a portion of the connecting elements 296.

FIG. 2C shows a top view of the thermal block emphasizing the connector element 296 which primarily includes openings 297 associated with the open spaces between walls 226, 227 & 228 so as to allow for flow of heat as well as passage of infrastructure elements (not shown). Note that the connector element 296 is generally present on the top and bottom of the thermal block 225 and not within the open spaces (obscured in this view) between walls 226, 227 & 228. When a plurality of thermal blocks 225 are stacked upon each other to create a building or structure, the open spaces openings 297 are also aligned one on top of another to allow for continuous air now as well as space for infrastructure placement from open spaces of a first block to open spaces of another block stacked above or below it.

Attention is turned to FIG. 2D. In this figure, the walls 226, 227, and 228 are all made of glass, Plexiglass or other clear material so as to act as a window 200, allowing light energy 210 to enter from an outside to an inside position of a building or structure. In this figure, two thermal blocks 225 are stacked one on top of another. Sun 205 provides energy 210 that passes through the first optically clear wall 226. The energy enters the first open space 290. As hot air 211 in the first open space 290 rises and as the two thermal blocks 225 as shown have openings in their connecting elements 296, the hot air 211 rises away before passing through the second glass wall 227. As such, a very small amount of energy 212 passes through the second glass wall 227 to pass through the second open space 295 and reach the third glass wall 228, with virtually no heat energy entering the room 230 associated with the thermal blocks 225 adapted to act as a window 200 for said room 230. Thus, the instant invention, by virtue of having open spaces 290 & 295 that run the height of a building or structure, allows for facile heat 211 removal to prevent unwanted heat from entering a room 230. The air in the first open space 290 may be allowed to rise on its own or it may be actively powered (not shown) so as to facilitate heat removal through the roof or other exit site for the hot air 211 between the first 226 and second 227 glass walls. The hot air 211 recovered may optionally be used for heating water or other predetermined purposes (not shown).

While any spacing 290 & 295 is theoretically possible between the walls 226, 227 & 228 of the instant thermal block, a typical block 225 will have 20 centimeters between the first 226 and second 227 walls and between the second 227 and third 228 walls. The dimensions for the open spaces 290 & 295 do not have to be equal but may be different in size. While the first open spacing 290 is primarily adapted to allow for unwanted heat energy 211 removal, the second open spacing 295 may also perform the same task in places where there is a great deal of sunlight 205 and high temperatures.

### Second Embodiment

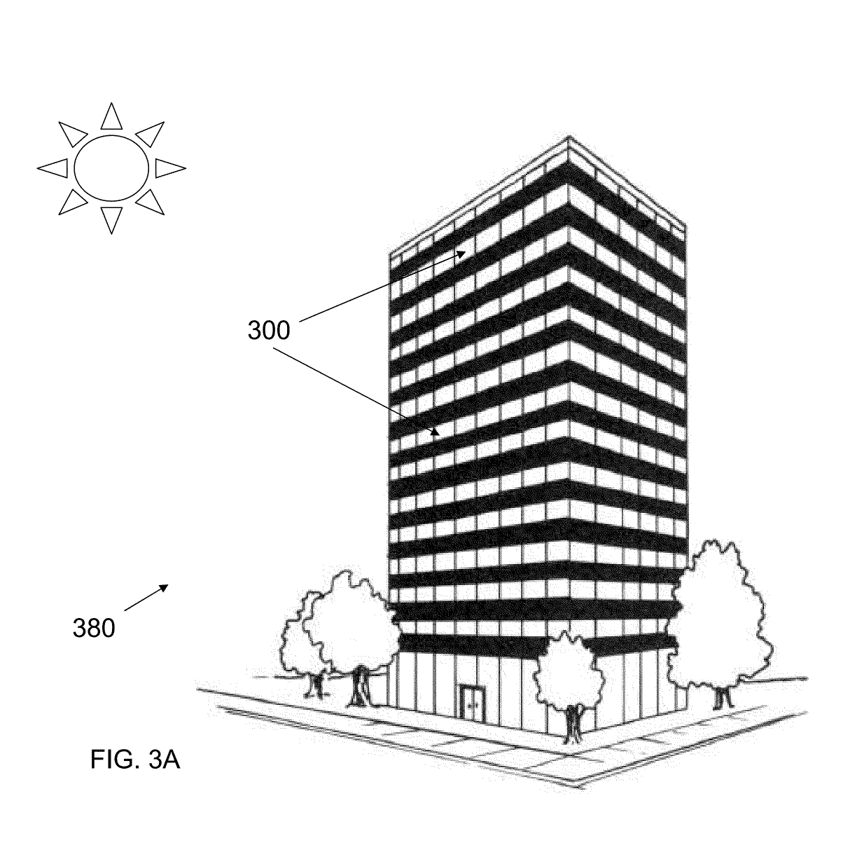

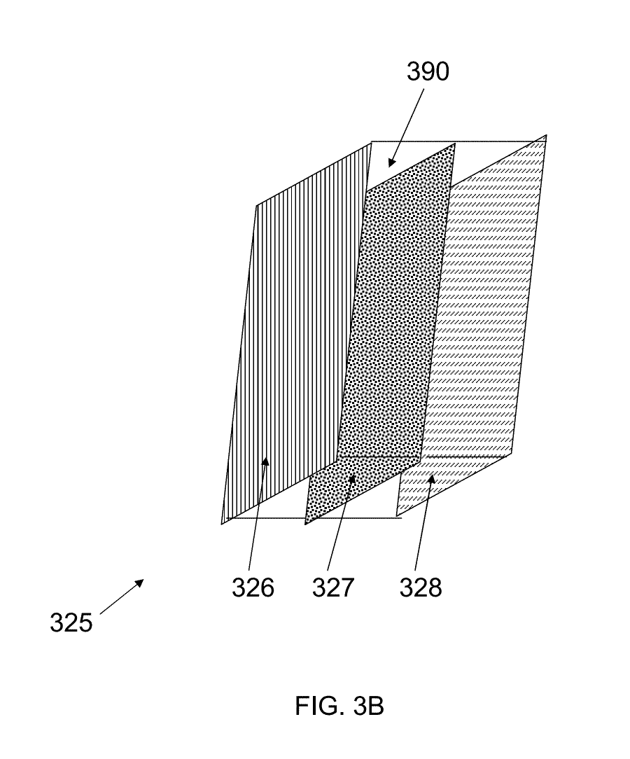

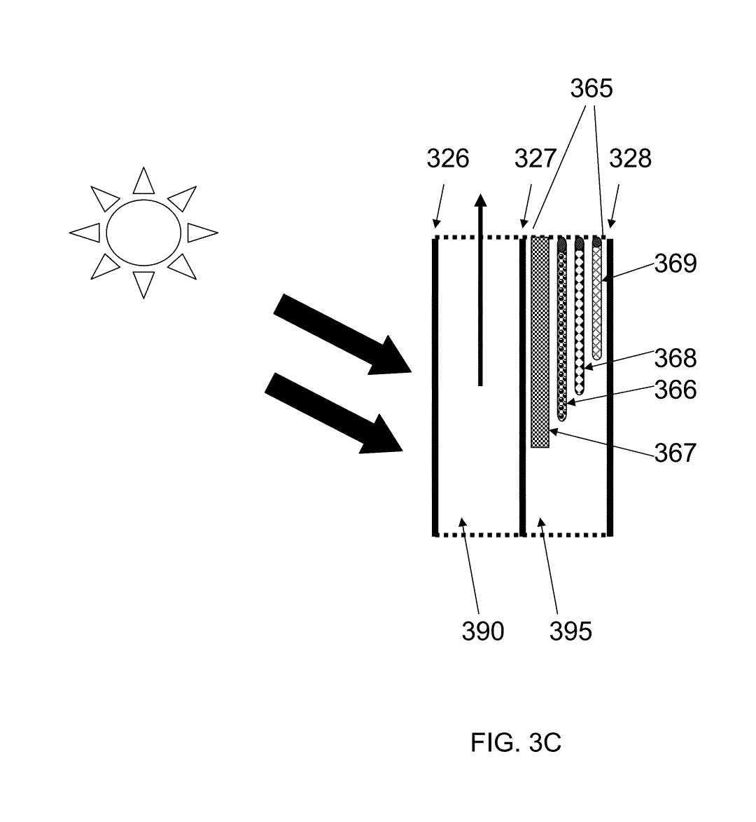

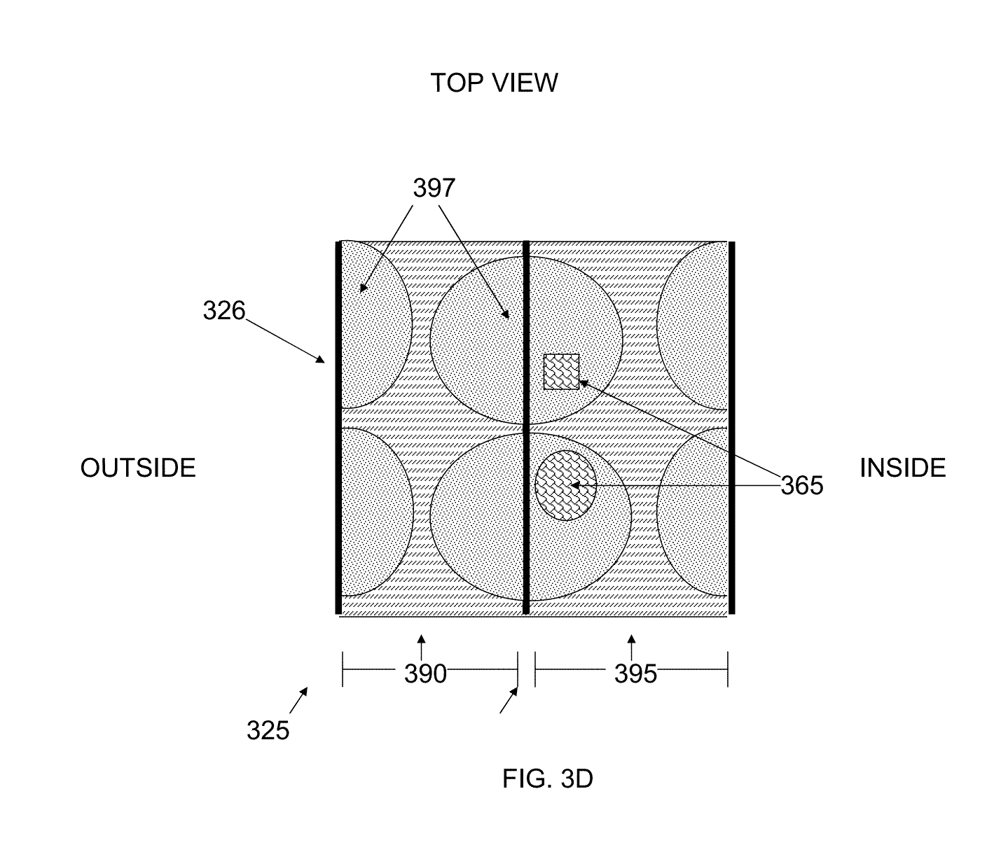

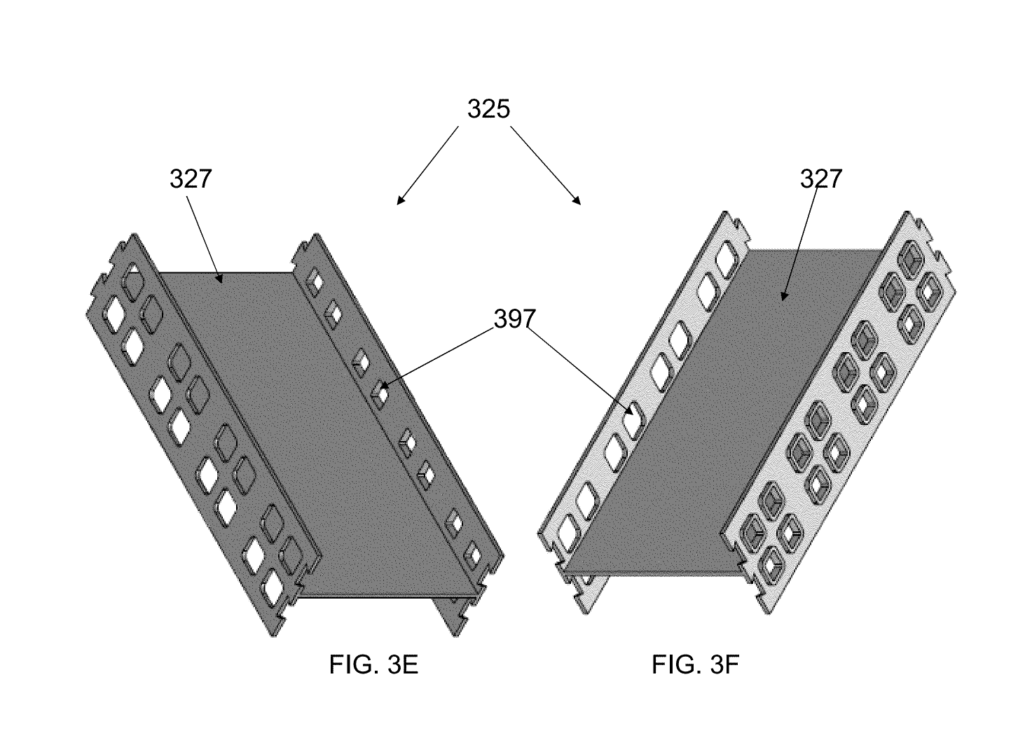

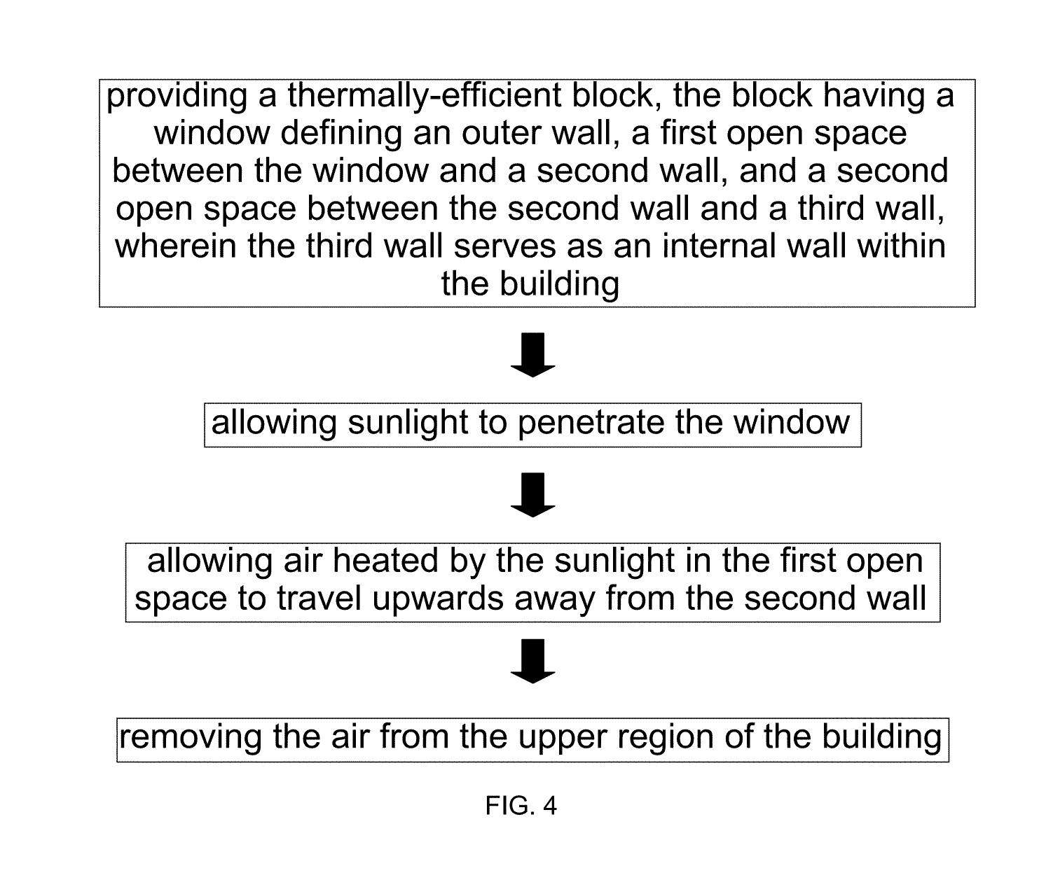

Attention is turned to FIG. 3A. Shown is a typical “glass and steel” structure 380. Such a structure 380 may be an office building or an apartment building or a combination of both. The structure 380 is primarily made of windows 300, which both allow for light/heat to enter the building as well as provide a beautiful, consistent external aesthetic. While the outside of the structure 380 is consistent in its physical appearance, the inside is anything but. Rooms are divided into work and living areas, closets, bathrooms, utility areas, and open spaces. Not all of these types of spaces need or benefit from a window: bathrooms certainly do not need a window facing outwards, and a utility room also has no benefit from being surrounded from the outside by windows. Thus, while the outside of the structure 380 makes ample use of windows and glass, the inside needs only a fraction of such window 300 space for actual user benefit.

Attention is turned to FIG. 3B which shows a block 325 adapted for a building such as described in this embodiment. The outer wall 326 is made of glass or other generally transparent material consistent with the overall external appearance of the building. The middle wall 327 is made of painted concrete while the inner wall 328 is made of drywall. Such an arrangement allows the outside of a building to be made completely of a glass exterior as is common in modern high-rise structures. The middle wall 327 serves with the first inner space 390 to stop excess beat and light from entering the building while the inner wall 328 is functional drywall which may be used for the walls of interior rooms like bedrooms, bathrooms and the like. This arrangement of elements preserves the elegance of the building exterior while preventing excess heat from entering a building. Additionally, the block 325 allows for functional interiors due to the presence of the inner wall 328 made of material different from the glass outer wall 326.

Attention is turned to FIG. 3C which shows a side view of the block shown in FIG. 3B. While the first open space 390 is placed between the first wall 326 of glass and the painted concrete second wall 327, the second open space 395 is placed between two walls 327 & 328 that are optically opaque (concrete and drywall). This arrangement allows space for running infrastructure elements 365 throughout the building (not shown). Wires 366, insulation 367, water pipes 368, and TV/phone cables 369 are non-limiting examples of infrastructure elements 365 that may be placed in the second open space 395, as these elements 365 are hidden from human eye both from outside the building and within. Obviously, one could run some or all infrastructure elements 365 through the first open space 390, though such elements 365 might be visible to the outside via the window first wall 326, unless special coatings (not shown) were placed on the first wall 326 so as to make seeing into the first open space 390 more difficult.

Attention is turned to FIG. 3D, which shows the block 325 from FIG. 3C from a top view. While the openings 397 present in the first open space 390 transport heat that has entered the first wall 326 window, the openings 397 in the second open space 395 may be used to transport the infrastructure elements 365 vertically through multiple blocks (not shown) and throughout the building (not shown). Thus, the open spaces 390 & 395 which include large openings 397 serve two major functions: removal of energy entering through the first wall 326 and placement of infrastructure elements 365 that need to be run throughout the building, including but not limited to wires, pipes, cables, insulation and other elements that allow for the routine function of a building. See FIG. 3C where both functionalities are schematically displayed.

FIGS. 3E & 3F shows a schematic reduced view of a block 325 showing the second wall 327 with the associated large openings 397. Note the “double T” shape of this arrangement without first and third walls present

### Third Embodiment

The invention includes a method for preventing unwanted thermal energy from entering the usable space of a building via a window, including: providing a thermally-efficient block, the block having a window defining an outer wall, a first open space between the window and a second wall, and a second open space between the second wall and a third wall, wherein the third wall serves as an internal wall within the building; allowing sunlight to penetrate the window; allowing air heated by the sunlight in the first open space to travel upwards away from the second wall; and, removing the air from the upper region of the building. As described, the method includes a window facing outwards. If the block is to serve as a window, then both the second and third walls must also be optically clear, so that someone inside can benefit from both the light as well as any view from said window. Most of the heat leaves the building by travelling up the first open spaces of a plurality of blocks stacked on top of each other. Air may be blown through the first open space so as to drive heat removal; alternatively, as hot air rises, the heat will dissipate by itself through an appropriate opening at the top of the building. In this method, all three walls may be represented as window panes, and the open spaces are open from both the top and bottom of the regions connecting the three panes. No infrastructure elements are run through the second open space so as not to interfere with the view from the window, though some elements might be run along the sides of the second open space so as not to interfere with the view.

### Fourth Embodiment

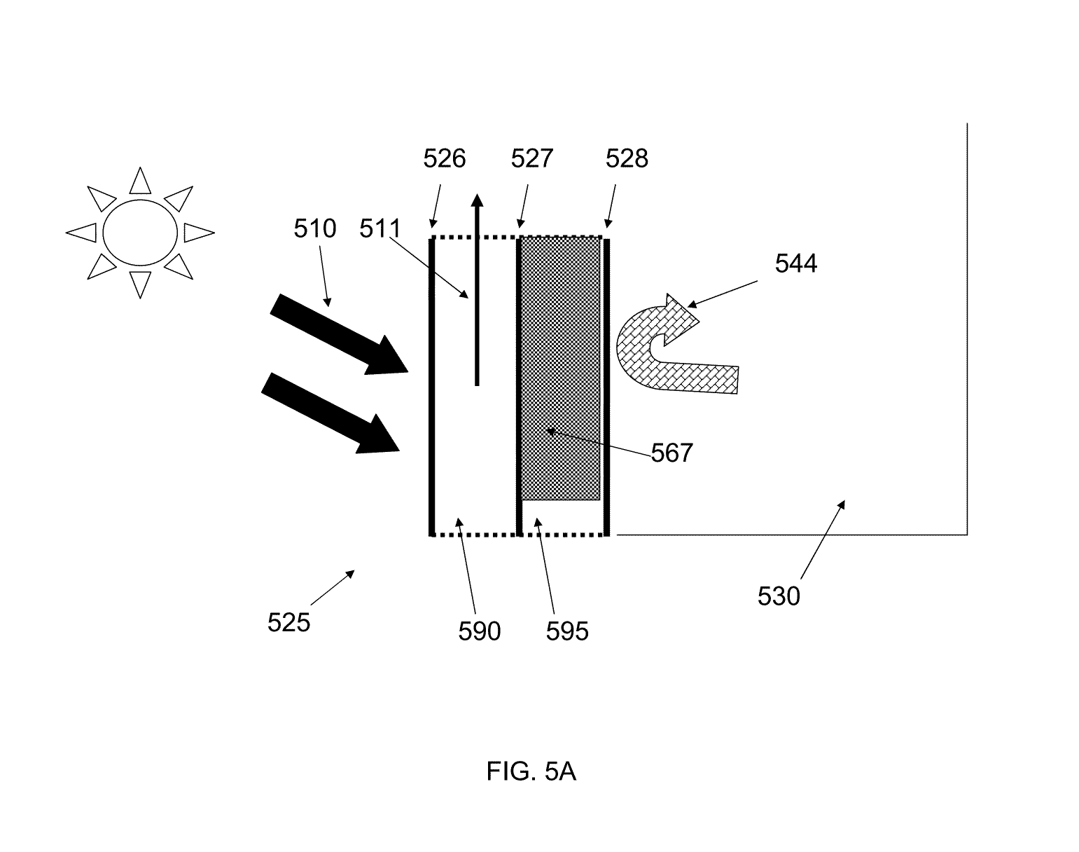

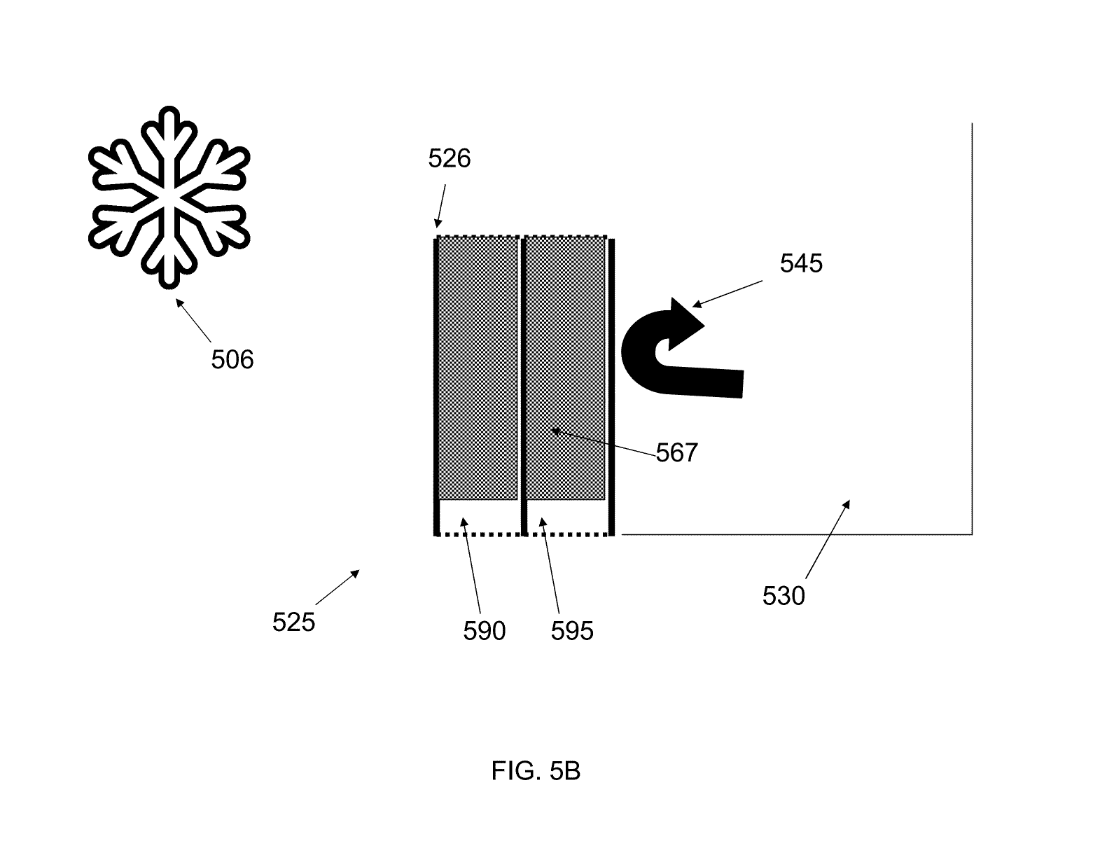

Attention is turned to FIG. 5A which shows a schematic view of an embodiment of the instant invention. The thermal block 525 is adapted to keep heat out of and cool air in a building, thus saving on heating and cooling costs. The block 525 directs external thermal energy 510 that passes through 511 the first wall 526 into a first open space 590 and out of the building. The second open space 595 may be filled with insulation 567 or other appropriate material to keep cool air 544 inside a room 530 for which the third wall 528 acts as a wall. The thermal block 525 in having three unique walls 526, 527 & 528 defining two open spaces 590 & 595 thus allows for both active removal of unwanted solar 505 heat 511 as well as preservation of desirable cool air 544 in a room 530 used by inhabitants or workers of the associated building. If the first wall 526 is realized as glass, while the second wall 527 is concrete and the third wall 528 is drywall, then the continuous glass exterior of the building is not compromised, while valuable energy is saved by removing unwanted heat 511 from the building and keeping desired cool air 544 in spaces used by occupants of the building.

Attention is turned to FIG. 511. The thermal block 525 is adapted to keep warm air 545 in a room 530 during winter. In this embodiment, the thermal block 525 may have insulation 567 in one or both open spaces 590 & 595 in order to keep warm air 545 in a room 530 during winter 506 season. The insulation 567 will be placed in the thermal block 525 prior to construction and not added on-site. Choosing to add insulation 567 to one or both open spaces 590 & 595 is a function of climate where building occurs as well as exposure or a lack thereof to the sun. If the first wall 526 is realized as a window pane, then a coating (not shown) may be placed over the first wall 526 so as to hide the presence of insulation 567 in the first open space 590.

It is understood that heat can be converted to other forms of energy directly or otherwise for the production of electricity, cooling, or heating of a building or other space.

### Fifth Embodiment

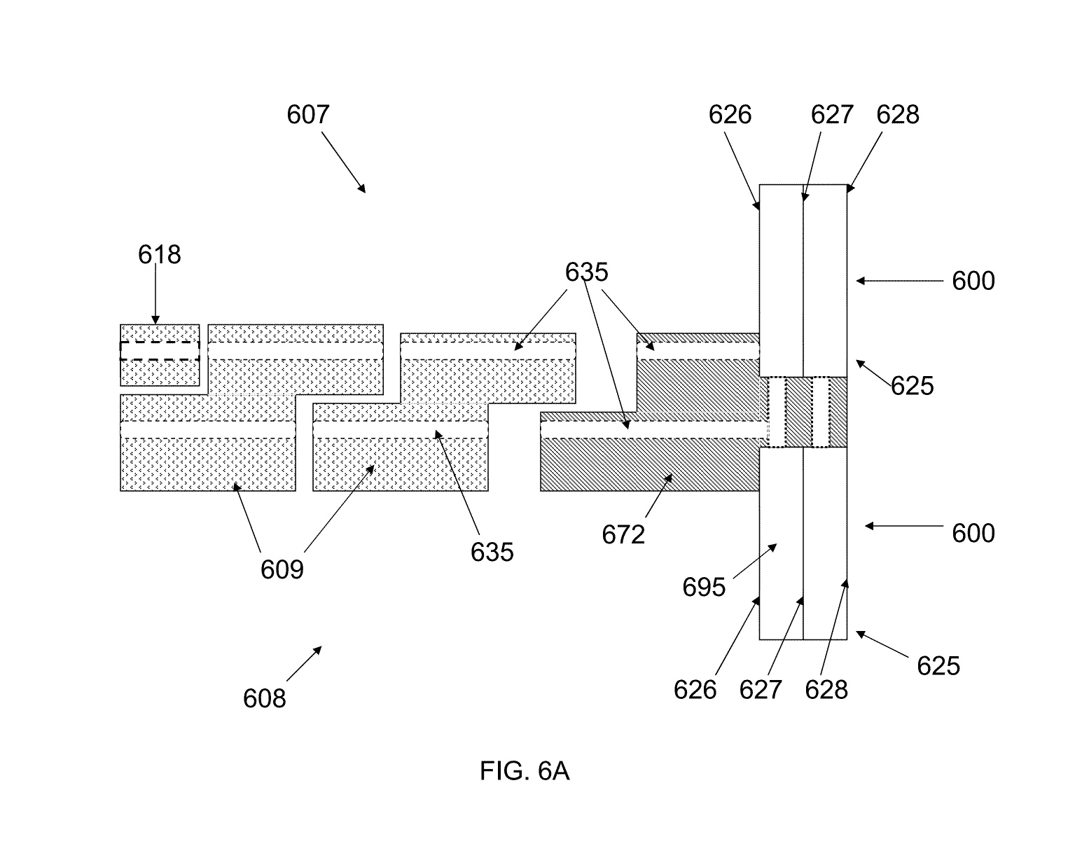

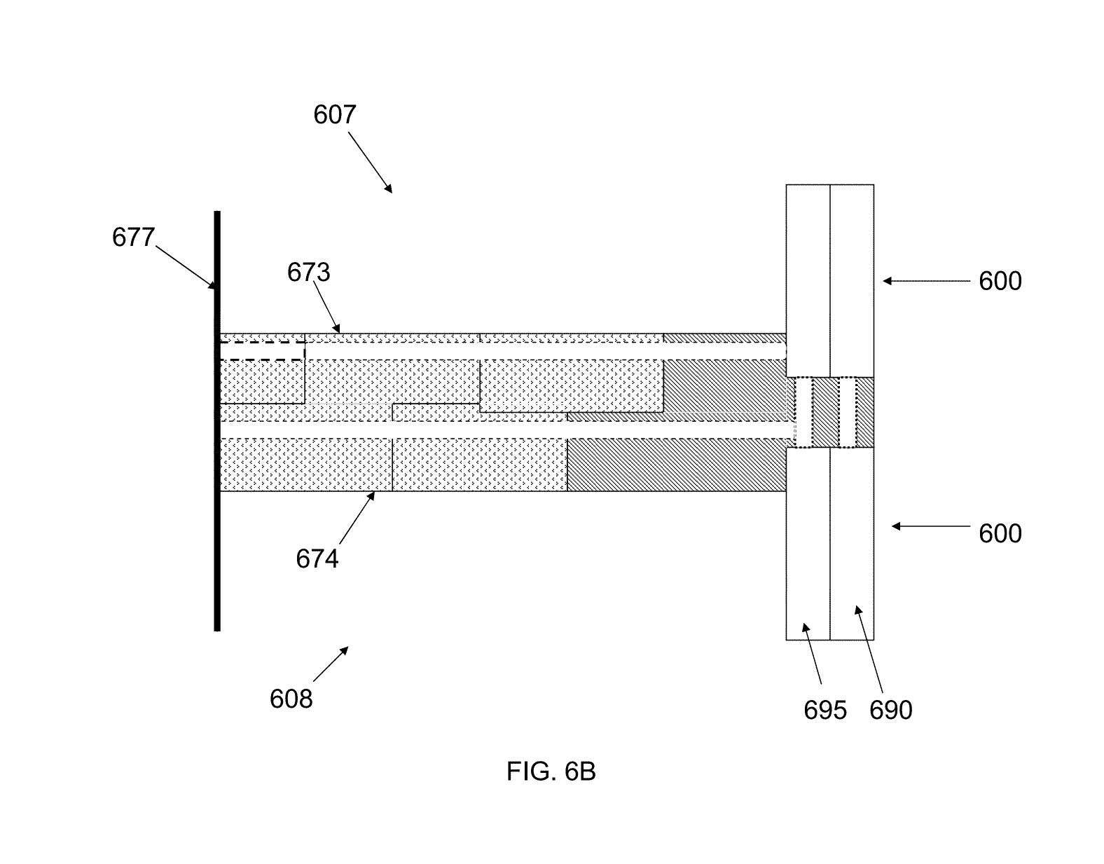

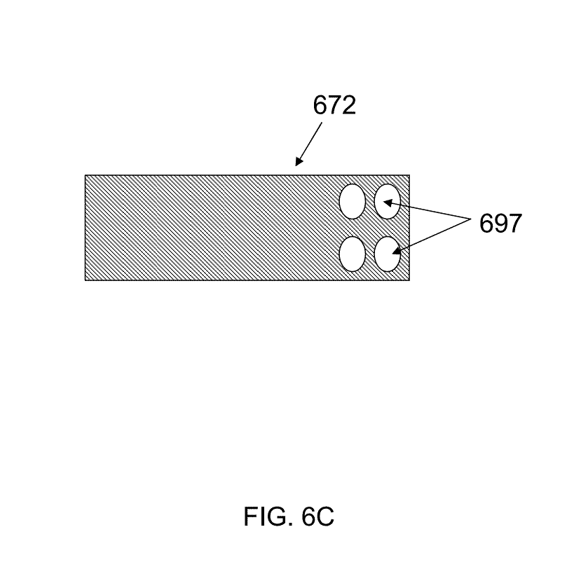

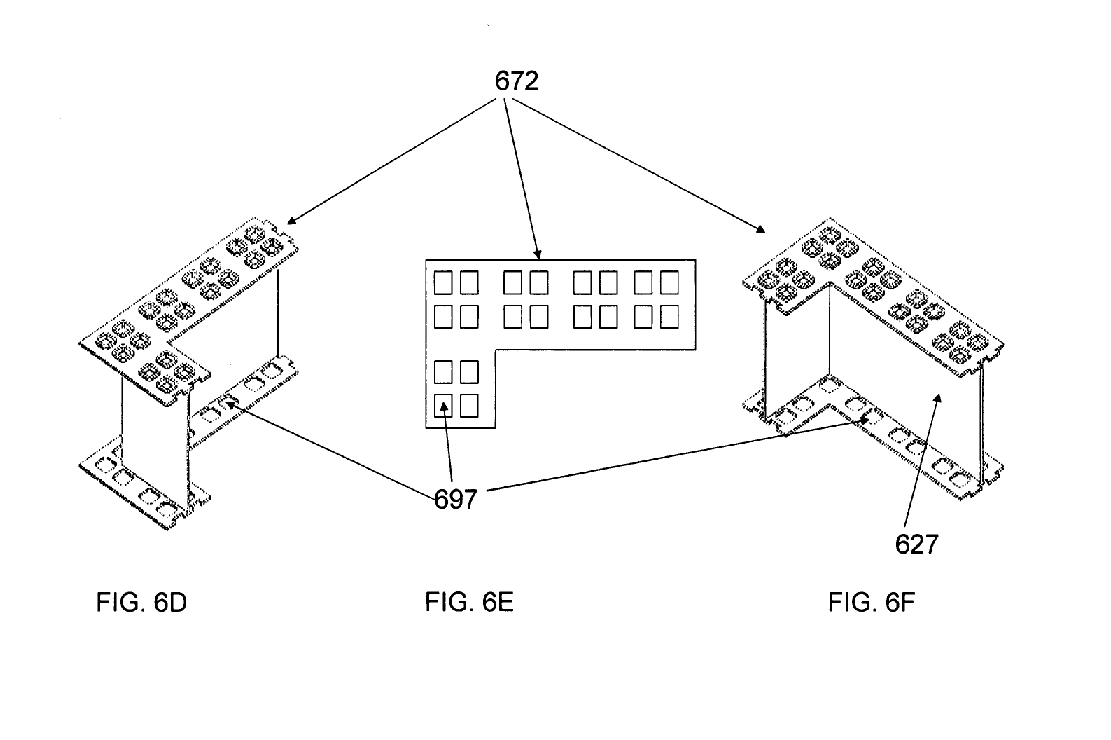

Attention is turned to FIG. 6A which shows a schematic view of a preferred embodiment of the instant invention. Two windows 600 are made from blocks 625 that include first 626, second 627, and third 628 walls as described in previous embodiments. The windows 600 are attached to a joining block 602 which includes fixtures (not shown) to firmly attach both windows 600. The joining block 672 includes space for infrastructure elements 635 which may be threaded through to the second open space 695 of the windows 600. The joining block 672 serves to anchor windows 600 and also serves as the starting point for the floor of the upper 607 floor and the ceiling for the lower 608 floor, as represented by the windows 600. The joining block 672 may be further connected to floor/ceiling blocks 609 adapted to attach to the joining block 672 and one another. The floor/ceiling blocks 609 include space for running infrastructure elements 635. Such infrastructure elements 635 include wires, pipes, and cables (not shown) typically run through ceilings and floors for water, electricity and phone/internet connectivity. At the end of a room, a finishing block 618 is attached to a floor/ceiling block 609 so as to complete the floor construction of the upper floor 607.

Attention is turned to FIG. 6B which shows an upper 607 and lower 608 floor after building according to the instant embodiment. Windows 600 define one end of two rooms, with a floor 673 and ceiling 674 defined by the blocks described above, with an inner wall 677 defining the other end of the upper 607 and lower 608 moms.

Attention is turned to FIG. 6C. In the figure is seen a joining block 672 from a top view. Large openings 697 are placed on the joining block 672 to as to afford continuity between open spaces between blocks stacked above and below (not shown) the joining block 672. These large openings 697 afford movement of hot air (not shown) as well as infrastructure elements (see FIG. 6A) so as to allow unfettered movement of energy and elements through the blocks defining the walls of a structure.

FIGS. 6D-6F show additional schematic views of the joining block 672 emphasizing the large holes 697 top and bottom adapted for air movement and infrastructure passage between floors. In this reduced view, only the middle wall 627 of the joining block 672 is present for view.

### Example

A five-story “glass and steel” structure is to be built. The building includes windows (FIG. 6, 600) that run the height of the building. The windows 600 have a first wall which is made of glass including a green reflective coating on the exterior of the first wall. Where said windows 600 serve as conduits of light for inner rooms, the second and third walls are also made of glass. Where said windows 600 face closed portions of the inner structure, the second wall is made of concrete, while the third wall is made of dryboard. Joining blocks 672 are placed between windows 600 and serve to build floors and ceilings from floor/ceiling blocks 609 to define inner mom structures. Cables, wires, pipes, and other infrastructure elements 635 are run through the second open spaces of the windows 600, being threaded through large openings 697 designed in part for such purposes in the second open spaces 695. Additional elements such as doors, light fixtures, toilets, and the like may be added to complete the entire internal and external structure. The windows include aligned first open spaces 690 which allow for the movement of hot air up and out of the building, thus reducing unwanted thermal energy from penetrating through the second and third walls associated with each window.

It is understood that some embodiments of the instant invention may include a plurality of thermal blocks for the construction of a building or structure. Thermal blocks may be realized as floor elements or roof components, and the thermal blocks may be used alone or in combination with traditional building materials to realize a complete structure. The connecting elements (296, FIG. 2C) form a general “double T” structure between the walls and thus offer very good strength for the block in load-bearing situations.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6 This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. The present invention could be employed for a wide variety of embodiments with differentially sized flotation elements as herewith described. The instant invention may be employed in dosing of other medications not directly described herewith.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed:

1. A thermally efficient building block including the following:
three parallel walls of similar dimensions, said walls being composed of predetermined materials and attached at points at the base and top of said walls, wherein said walls may be made of the same or different materials and said points of attachment create a first open space between a first of said walls and a second of said walls, as well as a second open space between said second of said walls and a third of said walls, wherein said first open space is adapted to allow for the flow of hot air upwards and away from said second of said walls.

2. The block according to claim 1, wherein said walls are made of optically-clear materials.

3. The block according to claim 1, wherein said block is used in the construction of a multi-story building.

4. The block according to claim 1, wherein said second open space is adapted to receive infrastructure elements.

5. The block according to claim 4, wherein said infrastructure elements include pipes, wires, cables, and insulation.

6. The block according to claim 1, wherein spacing between said first of said walls and said second of said walls is twenty centimeters.

7. The block according to claim 1, wherein spacing between said second of said walls and said third of said walls is twenty centimeters.

8. The block according to claim 1, wherein stacking of a plurality of said blocks leads to a first continuous open space comprised of multiple first open spaces and a second continuous open space comprised of multiple second open spaces.

9. The block according to claim 1, wherein said first wall is realized as a window and said third wall is realized as dryboard or concrete.

10. A method for preventing thermal energy from entering the usable space of a building via a window, including:
providing a thermally-efficient block, said block having a window defining an outer wall, a first open space between said window and a second wall, and a second open space between said second wall and a third wall, wherein said third wall serves as an internal wall within said building;
allowing sunlight to penetrate said window,
allowing air heated by said sunlight in said first open space to travel upwards away from said second wall; and,
removing said air from the upper region of said building.

11. The method according to claim 10, wherein said window is tinted.

12. The method according to claim 10, wherein said window includes at least one chemical coating against glare or heat transfer.

13. The method according to claim 10, wherein said upper region is realized as the roof of said building.

14. The method according to claim 10, wherein said second wall and said third wall are optically-transparent.

15. The method according to claim 10, wherein infrastructure elements are run through said second open space.

16. A thermally efficient building block for reducing heating and cooling expenses for a structure, including the following:
a building block defined by three connected and parallel surfaces separated by two open cavities, said open cavities being substantially open on the top and bottom, wherein said cavities allow for the passage of infrastructure elements as well as control of movement of hot and cold air between said surfaces; and,
a connector block, wherein said connector block has a generally T-shaped structure and is adapted to attach to and hold in place two of said building blocks, and wherein said connector block is substantially open so as to allow for the control of movement of hot and cold air between said surfaces.

17. The block according to claim 16, wherein all external walls of said structure are built with said block and said connector block

18. The block according to claim 17, wherein hot air is allowed to travel up through at least one of said two open cavities.

19. The block according to claim 16, wherein said surfaces are made of different materials.

20. The block according to claim 16, wherein said block is realized as a plurality of blocks ad said connector block is realized as a plurality of connector blocks.

21. 1. A thermally efficient window for use in construction of a building, including the following:
three parallel panes of optically-clear material of similar dimensions, said panes being composed of predetermined materials and attached at points at the base and top of said panes, wherein said panes may be made of different materials and said points of attachment create a first open space between a first of said panes and a second of said panes, as well as a second open space between said second of said panes and a third of said panes, wherein said first open space is adapted to allow for the flow of hot air upwards and away from said second of said panes and out of said building.
